(19) United States
(12) Patent Application Publication
(10) Pub. No.: US 2007/0267436 A1
(43) Pub. Date: Nov. 22, 2007

(54) Container and a cap having simultaneous sealing of two orifices

(75) Inventors: Douglas A. Abbott, Easton, PA (US); Jennifer Branda, Bethlehem, PA (US); Daniel L. King, Sussex, NJ (US)

Correspondence Address: Paul D. Greeley;Ohlandt, Greeley, Ruggiero & Perle, L.L.P., 10th Floor, One Landmark Square, Stamford, CT, 06901-2682, US

(73) Assignee: PECHINEY PLASTIC PACKAGING, INC.

(21) Appl. No.: 11/437,403

(22) Filed: May 19, 2006

(51) Int. Cl. B65D 35/22; B67D 5/56

(52) U.S. Cl. 222/94; 222/129

(57) ABSTRACT

There is a dual-dispensing tube container. The container has an inner tube, an outer tube and a reclosable sealing member. The inner tube has an inner sleeve and an inner head. The inner sleeve defines an inner chamber therein adapted to retain a first component composition. The inner head defines an inner neck. The inner neck is in communication with the inner chamber. The outer tube has an outer sleeve and an outer head. The outer sleeve defines an outer chamber therein adapted to retain a second component composition. The outer head defines an outer neck. The outer neck is in communication with the outer chamber. The inner tube is situated and locked within the outer tube. The inner neck is situated at least partially within the outer neck. The tube container is adapted to simultaneously dispense the first and second component compositions upon squeezing of the tube container. The reclosable sealing member simultaneous plugs the flow of the first and second component compositions from the inner and outer tubes. The sealing member has a first plug and a second plug. The second plug has an inner periphery. The first plug is situated within the inner periphery of the second plug. The tube container defines a first orifice therein and a first bore therethrough communicating between the first orifice and the inner chamber. The tube container defines a second orifice therein and a second bore therein communicating between the second orifice and the outer chamber. The first plug is adapted for insertion into and substantial plugging of the first orifice and/or the first bore, and the second plug is adapted for insertion into and plugging of the second orifice and/or the second bore.

### BACKGROUND OF THE INVENTION

1. Field of the Invention

The present invention relates to a dual-dispensing container. More particularly, the present invention relates to a container having a cap with two orifices from which different substances can be dispensed simultaneously. Still more particularly, the present invention relates to a container having a cap adapted for simultaneous sealing of the two orifices.

2. Description of the Related Art

Dual-dispensing containers that dispense a product having two different component compositions are known in the art. One particular application is the dispensing of toothpaste having two component compositions of different color that coalesce at an orifice.

Although containers have been effective in maintaining separation of toothpaste component compositions, they have not been effective at preventing drying and aggregation in or around the orifice. Drying an aggregation of toothpaste may prevent the cap from completely closing. If a cap cannot completely close, toothpaste may become contaminated with dust. Further, difficulty in closing the cap can be inconvenient and frustrating for the user.

Accordingly, there is a need for a dual-dispensing container that prevents contamination, drying, and aggregation of product at an outlet or orifice. There is a further need for a dual-dispensing container that can be re-closed without undue effort by the user.

### SUMMARY OF THE INVENTION

According to the present invention, there is a dual-dispensing tube container for dispensing two compositions simultaneously. The tube container has an inner tube, an outer tube, and a sealing member. The inner tube has an inner sleeve and an inner head. The inner sleeve defines an inner chamber therein adapted to retain a first component composition. The inner head defines an inner neck. The inner neck has an inner orifice therein and an inner bore therethrough in communication with the inner orifice and the inner chamber. The outer tube has an outer sleeve and an outer head. The outer sleeve defines an outer chamber therein adapted to retain a second component composition. The outer head defines an outer neck. The outer neck has an outer orifice therein and an outer bore therethrough in communication with the outer orifice and the outer chamber. The inner tube is situated and locked within the outer tube. The inner neck is situated within the outer neck. The tube container is adapted to simultaneously dispense the first and second component compositions upon squeezing of the tube container. The sealing member simultaneously plugs the inner orifice and the outer orifice. The sealing member has a first plug and a second plug. The outer periphery of the first plug has substantially the same shape as the inner periphery of the inner orifice. The outer periphery of the second plug has substantially the same shape as the inner periphery of the outer orifice. The first plug is situated within the inner periphery defined by the second plug. The first plug is adapted for insertion into the inner orifice and the second plug is adapted for insertion into the outer orifice.

### DESCRIPTION OF THE DRAWINGS

FIG. 1 is a perspective view of an embodiment of a container according to the present invention.

FIG. 2 is a fragmentary, perspective view of the container of FIG. 1 with the lid in partially open position.

FIG. 3 is a fragmentary, perspective view of the outer tube of the container of FIG. 1.

FIG. 4 is a fragmentary, perspective view of the inner tube of the container of FIG. 1.

FIG. 5 is a fragmentary, cross-section view of the container of FIG. 1 taken along line A-A seen in FIG. 1 with a reference to a detail view referenced by the numeral 7 and shown in FIG. 7.

FIG. 6 is a fragmentary, cross-section view of the container of FIG. 2 taken along line B-B.

FIG. 7 is an enlarged view of a detail view of FIG. 5.

FIG. 8 is a fragmentary, enlarged, perspective view of the container of FIG. 1 with the lid in open position.

### DETAILED DESCRIPTION OF THE INVENTION

According to the present invention there is a dual-dispensing tube container. The container has an inner tube, an outer tube and a reclosable sealing member. The inner tube has an inner sleeve and an inner head. The inner sleeve defines an inner chamber therein adapted to retain a first component composition. The inner head defines an inner neck. The inner neck is in communication with the inner chamber. The outer tube has an outer sleeve and an outer head. The outer sleeve defines an outer chamber therein adapted to retain a second component composition. The outer head defines an outer neck. The outer neck is in communication with the outer chamber. The inner tube is situated and locked within the outer tube. The inner neck is situated at least partially within the outer neck. The tube container is adapted to simultaneously dispense the first and second component compositions upon squeezing of the tube container. The reclosable sealing member simultaneous plugs the flow of the first and second component compositions from the inner and outer tubes. The sealing member has a first plug and a second plug. The second plug has an inner periphery. The first plug is situated within the inner periphery of the second plug. The tube container defines a first orifice therein and a first bore therethrough communicating between the first orifice and the inner chamber. The tube container defines a second orifice therein and a second bore therein communicating between the second orifice and the outer chamber. The first plug is adapted for insertion into and substantial plugging of the first orifice and/or the first bore, and the second plug is adapted for insertion into and plugging of the second orifice and/or the second bore.

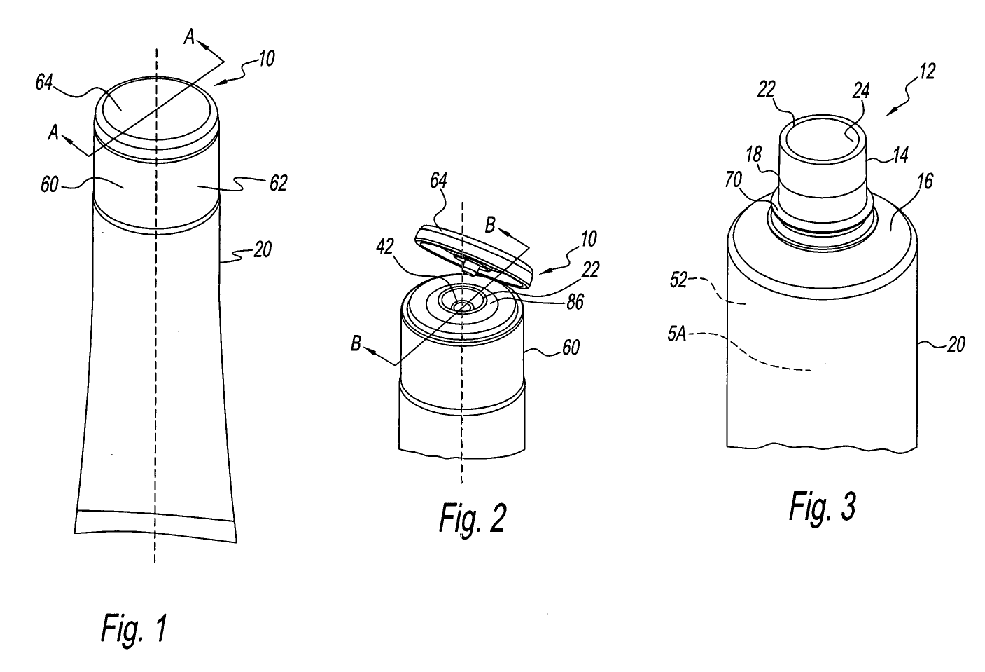

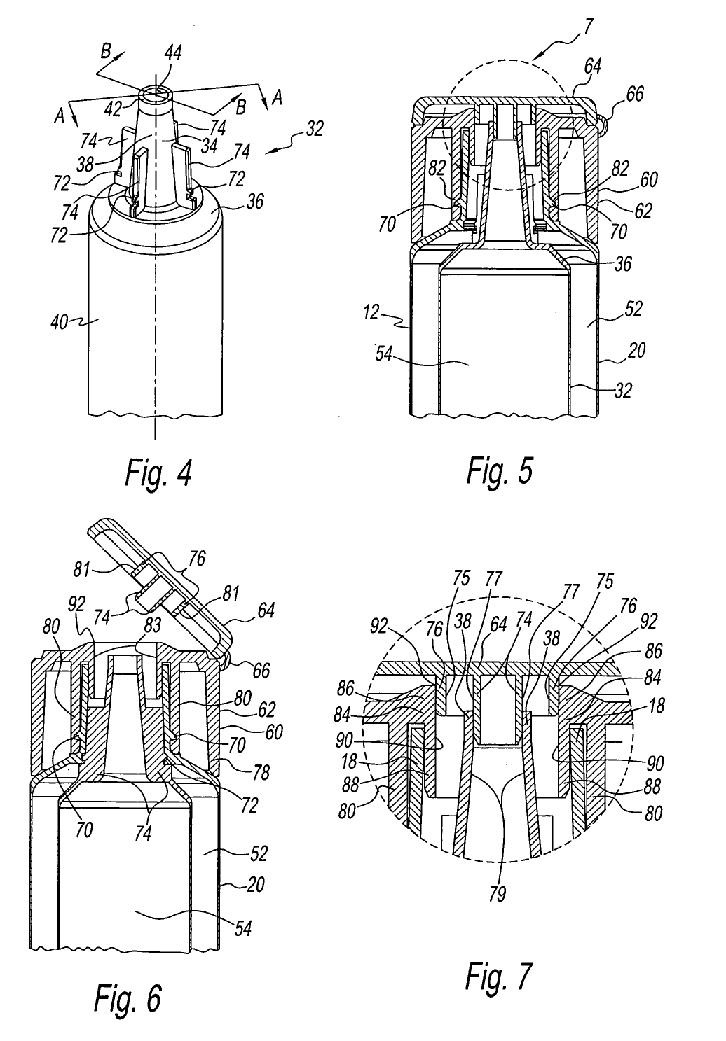

A dispensing container according to the present invention is shown in FIG. 1 and is generally referenced by the numeral 10. Container 10 has an outer tube 12 and an inner tube 32 as shown in FIGS. 3 and 4, respectively. Outer tube 12 is adapted to receive and retain inner tube 32. Inner tube 32 has a neck 38. Outer tube 12 has a neck 18 with a bore 24 therethrough. Neck 38 is positioned partially or entirely within bore 24. Inner tube 32 locks within outer tube 12 via snap beads 72, which axially protrude from ribs 74 as shown in FIG. 4. Ribs 74 run parallel to the longitudinal extension of neck 38 and provide a brace for maintaining centering of neck 38 within bore 24 in addition to providing snap beads 72. The relative positioning of outer tube 12 and inner tube 32 defines a chamber 52 between them to contain and retain the first component composition (not shown). Inner tube 32 further defines a chamber 54 within to contain and retain the second component composition (not shown). When container 10 is squeezed, the first component composition is forced out of chamber 52 through bore 24 and out an orifice 22. At the same time, the second component composition is forced out of chamber 54 through a bore 44 and out an orifice 42. The two component compositions coalesce to form a product composition (not shown).

Container 10 has a cap 60, which takes the form of a flip cap. As shown in FIGS. 5 and 6, cap 60 has a base 62, a lid 64, and a hinge 66. Lid 64 is flexibly affixed to base 62 via hinge 66. Lid 64 may be actuated about hinge 66 between open and closed position. Cap 60 is secured to head 14 via snap bead 70. If desired, alternative securement means, such mating screw threads (not shown), may also be employed. Base 62 has an outer skirt 78 and an inner skirt 80. Inner skirt 80 defines a circumferential groove 82 therein to receive snap beads 72 of neck 38. Base 62 also has a connecting member 84, which extends inward beyond inner skirt 80. Inner skirt 80, outer skirt 78, and connecting member 84 extend circumferentially around base 62. Connecting member 84 has an orifice seal 86 and a plug seal 88 that extends directionally with base 62. Orifice seal 86 and plug seal 88 define a plug bore 90 therein and around their interior surfaces. Orifice seal 86 also defines a plug orifice 92 therein.

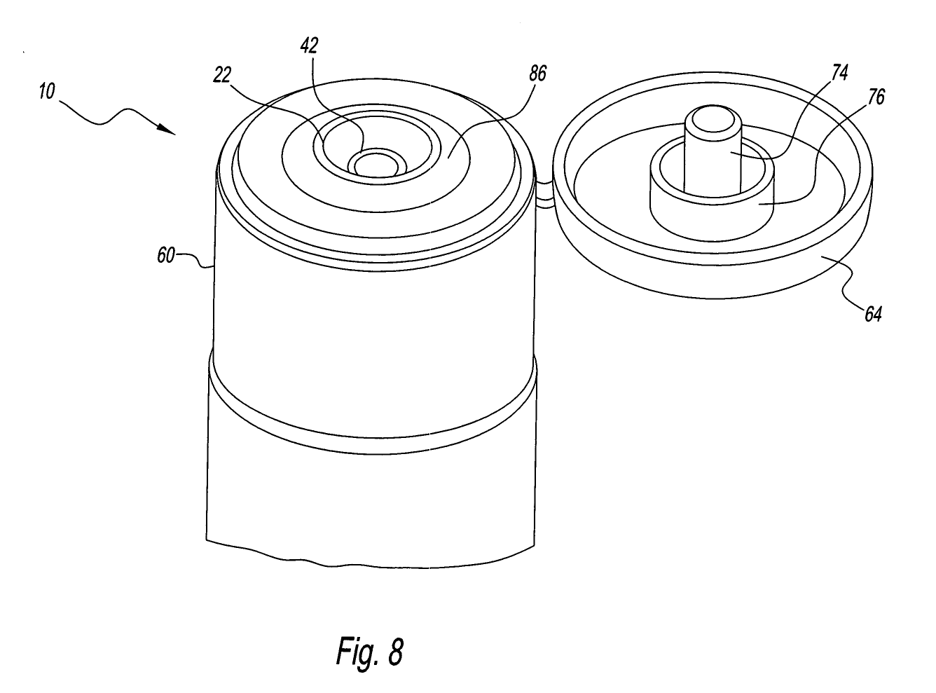

The primary sealing means or member takes the form of a first pintel 74 and a second pintel 76, which extend from the underside or bottom of lid 64 as shown in FIGS. 2 and 5 to 8. First pintel 74 and second pintel 76 extend from lid 64 in a cylindrical, i.e., circular in cross-section, configuration or shape. It is understood that the cross-sectional shape could be modified to another shape, such as a triangle, oval, square, pentagon or other polygon, if desired. It is also understood that first pintel 74 could be modified to extend from lid 64 in the form of a solid cylinder rather than an annular cylinder as depicted, if desired. First pintel 74 is situated inside the inner periphery 75 defined by second pintel 76. When lid 64 is in closed position, first pintel 74 extends into the inner periphery of orifice 42 and partially into bore 44 of neck 38. The outside diameter or outer periphery 77 of pintel 74 is wide enough with respect to the inside diameter or inner periphery 79 of orifice 42 to plug or substantially effect a seal at orifice 42 and/or bore 44. Most preferably, the outside diameter of pintel 74 is slightly greater than the inside diameter of bore 44. Also when lid 64 is in closed position, second pintel 76 extends into orifice 92 and partially into bore 90. The outside diameter or outer periphery of second pintel 76 is wide enough with respect to the inside diameter or inner periphery of orifice 92 and/or bore 90 to plug or substantially effect a seal within bore 90. Most preferably, the outside diameter or outer periphery 81 of second pintel 76 is slightly greater than the inside diameter or inner periphery 83 of orifice 92 and/or bore 90. Pintels 74 and 76 preferably have outer peripheries of substantially the same shape as the orifices and/or bores into which they are inserted (cross-sectional shape normal the longitudinal extension of the bores and pintels).

Dispensing tube containers of the present invention may be produced by any method known in the art, such as extrusion or lamination. In extrusion, a plastic tube sleeve for each of the inner and outer tubes is extruded continuously then cut into discrete lengths to form inner and outer sleeves of the tube container. Tube heads are then heat welded or adhered to one end of a tube sleeves, the tops of the necks snipped or removed to open them (if necessary), and closures in the nature of a cap applied to the neck. The remaining ends of the tube sleeves are typically filled with product to be dispensed and then sealed by known heat, adhesive, or mechanical methods. In lamination, a sheet of plastic material or composite such as plastic/metal foil is rolled to a tubular shape and sealed along the sheet edges to form continuous tube sleeves. The tube sleeves are cut into discrete lengths, heads and closures applied, filled with product at the open ends, and the end sealed in the same manner as an extruded tube. Laminates may have both extruded and non-extruded layers. Useful extrusion techniques include, but are not limited to, cast extrusion and blown extrusion.

The closures and heads may be manufactured according to any method known in the art, such as injection molding or stamping with a plastic material. Injection molding is preferred.

The tube container, including the tube sleeves, heads, and closures, may be manufactured from any plastic material known in the art. Representative plastic materials include, but are not limited to, ethylene polymers, propylene polymers, polyesters, and polyamides. Useful ethylene polymers include low density polyethylene, medium density polyethylene, high density polyethylene and linear low density polyethylene. A useful propylene polymer is polypropylene. Useful polyesters include polyethylene terephthalate. Preferred plastic materials for the head and the closure are high density polyethylene and polypropylene. A preferred plastic material for an extruded tube sleeve is low density polyethylene. Preferred plastic materials for laminate tube sleeves include low density polyethylene and linear low density polyethylene. Preferably, heads and closures are of a plastic material more rigid than the tube sleeves. Adhesive or tie layers may be employed as necessary. Plastic materials useful in adhesive layers include, but are not limited to, ethylene/vinyl acetate copolymers and ionomers.

The tube container is adapted to retain and dispense a variety of products in a variety of forms. Useful product forms include creams, pastes, ointments, lotions, liquids, gels, pomades, and the like.

It should be understood that the foregoing description is only illustrative of the present invention. Various alternatives and modifications can be devised by those skilled in the art without departing from the invention. Accordingly, the present invention is intended to embrace all such alternatives, modifications and variances.

What is claimed is:

1. A dual-dispensing tube container, comprising:
an inner tube having an inner sleeve and an inner head, the inner sleeve defining an inner chamber therein adapted to retain a first component composition, the inner head defining an inner neck, the inner neck being in communication with the inner chamber;
an outer tube, having an outer sleeve and an outer head, the outer sleeve defining an outer chamber therein adapted to retain a second component composition, the outer head defining an outer neck, the outer neck being in communication with the outer chamber, the inner tube being situated and locked within the outer tube, the inner neck being situated at least partially within the outer neck, the tube container being adapted to simultaneously dispense the first and second component compositions upon squeezing of the tube container;
a reclosable sealing member for simultaneous plugging of the flow of the first and second component compositions from the inner and outer tubes, the sealing member having first plug and a second plug, the second plug having an inner periphery, the first plug being situated within the inner periphery of the second plug, the tube container defining a first orifice therein and a first bore therein communicating between the first orifice and the inner chamber, the tube container defining a second orifice therein and a second bore therein communicating between the second orifice and the outer chamber, the first plug being adapted for insertion into and substantial plugging of the first orifice and/or the first bore and the second plug being adapted for insertion into and plugging of the second orifice and/or the second bore.

2. The tube container of claim 1, further comprising a flip cap, the flip cap having a base, a lid, and a hinge, the hinge flexibly attaching the lid to the base, the lid having a top surface and a bottom surface, the lid having the first plug and the second plug appending from the bottom surface.

3. The tube container of claim 2, wherein the sealing member is integrally formed with the flip cap.

4. The tube container of claim 2, wherein the first plug and the second plug are pintels.

5. The tube container of claim 1, wherein the base of the flip cap is affixable to the outer head via snap bead.

6. The tube container of claim 1, wherein the first plug and the second plug each have an outer periphery, and wherein the first orifice and the second orifice each have an inner periphery, and wherein the outer periphery of the first plug has substantially the same shape as the inner periphery of the inner orifice, and wherein the outer periphery of the second plug has substantially the same shape as the inner periphery of the outer orifice.

7. The tube container of claim 2, wherein the flip cap is affixed to the outer head.

8. The tube container of claim 1, wherein an connecting member drapes over and around a tip of the outer bore and extends at least partially inside and at least partially around the outer bore, wherein the connecting member defines an plug orifice therein and an plug bore therethrough, wherein the second bore is the plug bore and an outer bore extending through the outer neck, wherein the plug bore communicates with the outer bore and the outer bore communicates with the outer chamber, wherein the second orifice is the plug orifice, wherein the second plug is adapted for insertion into and plugging of the plug orifice and/or the plug bore, wherein the first orifice is an inner orifice within the inner neck, wherein the inner neck has an bore therethrough in communication with the inner orifice and the inner neck, wherein the first plug is adapted for insertion into and plugging of the inner orifice and/or the inner bore.
